(19) United States
(12) Patent Application Publication
(10) Pub. No.: US 2002/0188728 A1
(43) Pub. Date: Dec. 12, 2002

(54) Adaptive file transfer acceleration

(75) Inventor: Clinton L. Ballard, Suquamish, WA (US)

Correspondence Address: KODA LAW OFFICE, P.O. Box 10057, Bainbridge Island, WA, 98110, US

(73) Assignee: Acceleration Softwave International Corporation

(21) Appl. No.: 09/877,916

(22) Filed: Jun. 7, 2001

(51) Int. Cl. G06F 15/16

(52) U.S. Cl. 709/227

(57) ABSTRACT

File transfers between a client computer and a file server are accelerated by adaptively varying the number of connections between the two computers. The number of connections used is changed dynamically based on real-time feedback. Throughput measurements are taken continuously for variations of the current connections. The optimal number of connections can vary for different types of Internet connections. The actual number of connections that would be optimal for a specific transfer will change, perhaps even from minute to minute, depending on the user's Internet service provider (ISP), the modem speed, the current Internet traffic congestion and the server implementation.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent and Trademark Office file or records, but otherwise reserves all copyright rights whatsoever.

### BACKGROUND OF THE INVENTION

This invention relates to file transfer methods for a wide area network, and more particularly to an adaptive method which dynamically changes transfer parameters.

Conventional protocols for transferring files over a wide area network such as the Internet include the file transfer protocol (FTP) and the hypertext transfer protocol (HTTP). To transfer a file a connection is made between a client computer and a server computer. Typically one connection is made between the two computers. However, it is known to use multiple connections. A fixed number of connections are set and used to perform the file transfer. A shortcoming of the multiple connection process is observed at times where the transfer process is slower with multiple connections than with one connection. Accordingly, there is a need for an improved transfer process which more effectively accelerates file transfers.

### SUMMARY OF THE INVENTION

According to the invention, an adaptive file transfer method is implemented which dynamically varies the number of connections in use during a current file transfer based on real-time feedback. The optimal number of connections can vary for different types of Internet connections. The actual number of connections that would be optimal for a specific transfer will change, perhaps even from minute to minute, depending on the user's Internet service provider (ISP), the modem speed, the current Internet traffic congestion and the server implementation.

According to one aspect of the invention, the number of connections is varied as conditions change in real-time to use an optimum number of connections. Throughput measurements are taken continuously for variations of the current connections. The current number of connections is changed when it is advantageous. Under certain conditions, the bulk of the transfer will be done with one connection to minimize or eliminate the chance for deceleration.

According to one advantage of the invention, file transfer time is decreased by dynamically determining an optimum number of connections. Further, as the determined optimum number changes during a file transfer, the number of connections is changed correspondingly. A benefit of this is that a more reliable method of accelerating file transfers is achieved with the risk of actually decelerating the transfer process being reduced.

These and other aspects and advantages of the invention will be better understood by reference to the following detailed description taken in conjunction with the accompanying drawings.

### BRIEF DESCRIPTION OF THE DRAWINGS

FIG. 1 is a schematic diagram of an exemplary wide area network hosting the method of this invention;

FIG. 2 is a block diagram of a computer system for a computer connected into the network of FIG. 1;

FIG. 3 is a flow chart of a method for transferring a file over a wide area network using an adaptive number of connections; and

FIG. 4 is a diagram of a file divided into chunks for a file transfer operation.

### DESCRIPTION OF SPECIFIC EMBODIMENTS

Host Network Environment

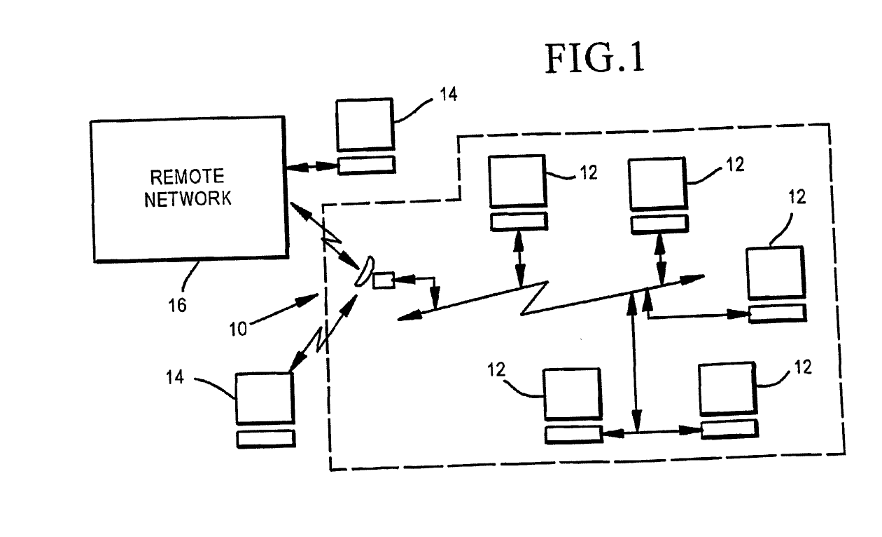

FIG. 1 shows a wide area network 10 formed by a plurality of network server computers 12 which are interlinked. Each network server computer 12 stores documents accessible to other network server computers 12 and to client computers 14 and networks 16 which link into the wide area network 10. The configuration of the wide area network 10 may change over time as client computers 14 and one or more networks 16 connect and disconnect from the network 10. For example, when a client computer 14 and a network 16 are connected with the network servers computers 12, the wide area network includes such client computer 14 and network 16. As used herein the term computer includes any device or machine capable of accepting data, applying prescribed processes to the data, and supplying results of the processes.

The wide area network 10 stores information which is accessible to the network server computers 12, remote networks 16 and client computers 14. The information is accessible as documents. The term document as used herein, includes files (as per the Windows operating system usage), documents (as per the MacOS operating system usage), pages (as per the web phraseology usage), and other records, entries or terminology used to describe a unit of a data base, a unit of a file system or a unit of another data collection type, whether or not such units are related or relational.

The network server computers 12 are formed by main frame computers minicomputers, and/or microcomputers having one or more processors each. The server computers 12 are linked together by wired and/or wireless transfer media, such as conductive wire, fiber optic cable, and/or microwave transmission media, satellite transmission media or other conductive, optic or electromagnetic wave transmission media. The client computers 14 access a network server computer 12 by a similar wired or a wireless transfer medium. For example, a client computer 14 may link into the wide area network 10 using a modem and the standard telephone communication network. Alternative carrier systems such as cable and satellite communication systems also may be used to link into the wide area network 10. Still other private or time-shared carrier systems may be used. In one embodiment the wide area network is a global information network, such as the Internet. In another embodiment the wide area network is a private intranet using similar protocols as the Internet, but with added security measures and restricted access controls. In still other embodiments the wide area network is a private, or semi-private network using proprietary communication protocols.

The client computer 14 is any end user computer, and may also be a mainframe computer, minicomputer or microcomputer having one or more microprocessors. The remote network 16 may be a local area network, a network added into the wide area network through an independent service provider (ISP) for the Internet, or another group of computers interconnected by wired or wireless transfer media having a configuration which is either fixed or changing over time. Client computers 14 may link into and access the wide area network 10 independently or through a remote network 16.

Computer System

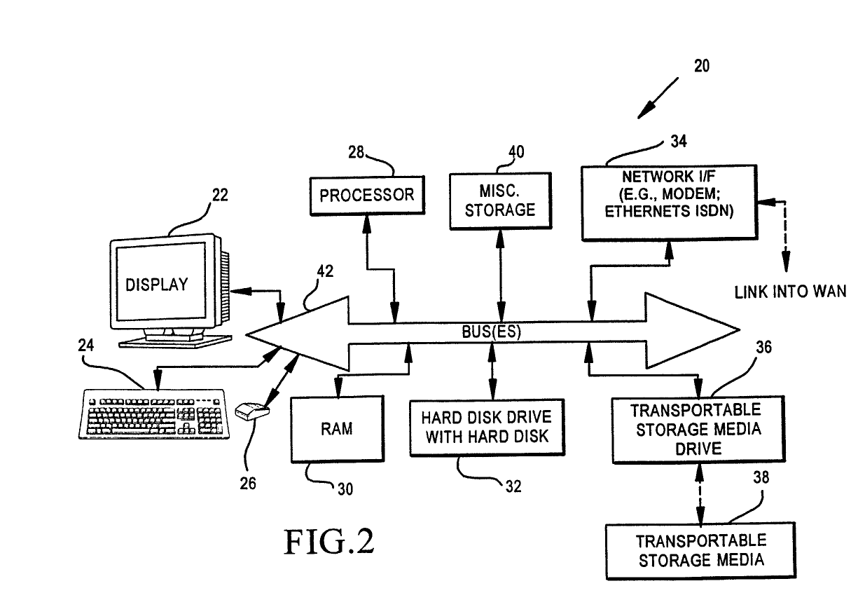

The functions of the present invention preferably are performed by programmed digital computers of the type which are well known in the art, an example of which is shown in FIG. 2. A computer system 20 has a display monitor 22, a keyboard 24, a pointing/clicking device 26, a processor 28, random access memory (RAM) 30, a non-volatile storage device such as a hard disk drive 32, a communication or network interface 34 (e.g., modem; ethernet adapter), and a transportable storage media drive 36 which reads transportable storage media 38. In addition other miscellaneous storage devices 40, such as a floppy disk drive, CD-ROM drive, zip drive, bernoulli drive or other magnetic, optical or other storage media, may be included. The various components interface and exchange data and commands through one or more busses 42. The computer system 20 receives information by entry through the keyboard 24, pointing/clicking device 26, the network interface 34 or another input device or input port. The computer system 20 may be any of the types well known in the art, such as a mainframe computer, minicomputer, or microcomputer and may serve as a network server computer 12, remote network 16 computer or a client computer 14. The computer system 20 may even be configured as a workstation, personal computer, network server, or a reduced-feature network terminal device.

File Transfer Method

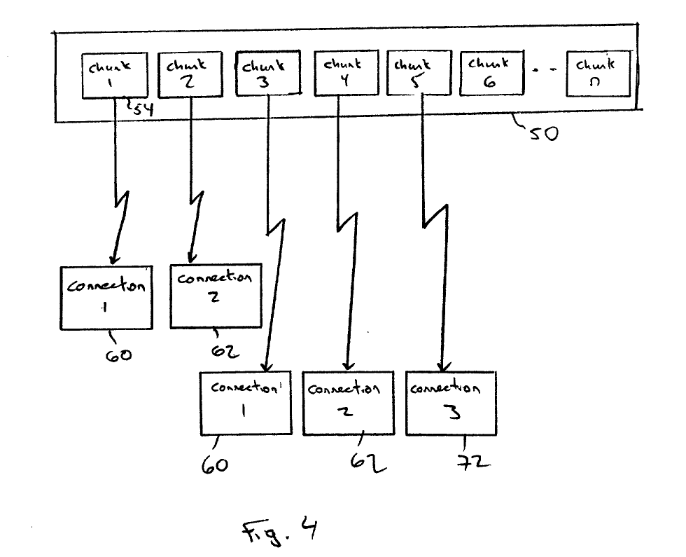

Referring to FIGS. 1 through 4 a file 50 (FIG. 4) is transferred over a wide area network 10 between two computers, (e.g., a file server 12 and a client computer 14). Consider the example where a client computer 14 requests to download a file from a file server 12. In one embodiment the client computer controls how many connections are established on the wide area network to accomplish the file transfer. The actual number of connections that would be optimal for a specific transfer will change, perhaps even from minute to minute, depending on the user's Internet service provider (ISP), the modem speed, the current Internet traffic congestion and the server implementation. In one embodiments an initial number of connections is set at two connections. The optimal number of connections varies for different types of Internet connections. Accordingly, in other embodiments the initial number varies. For example empirical observations of 2 connections and 5 connections have been found to be an optimal number of connections under various network 10 conditions.

When performing a file transfer the file 50 is transferred piecemeal in chunks 54. Each chunk 54 is packaged and routed over the wide area network according to a conventional file transfer protocol (e.g., such as the FTP or HTML protocols used on the Internet). For example a given chunk is packages into one or more packets and transferred. Associated with each chunk transfer is overhead information. For example, associated with each packet is prescribed header and footer information.

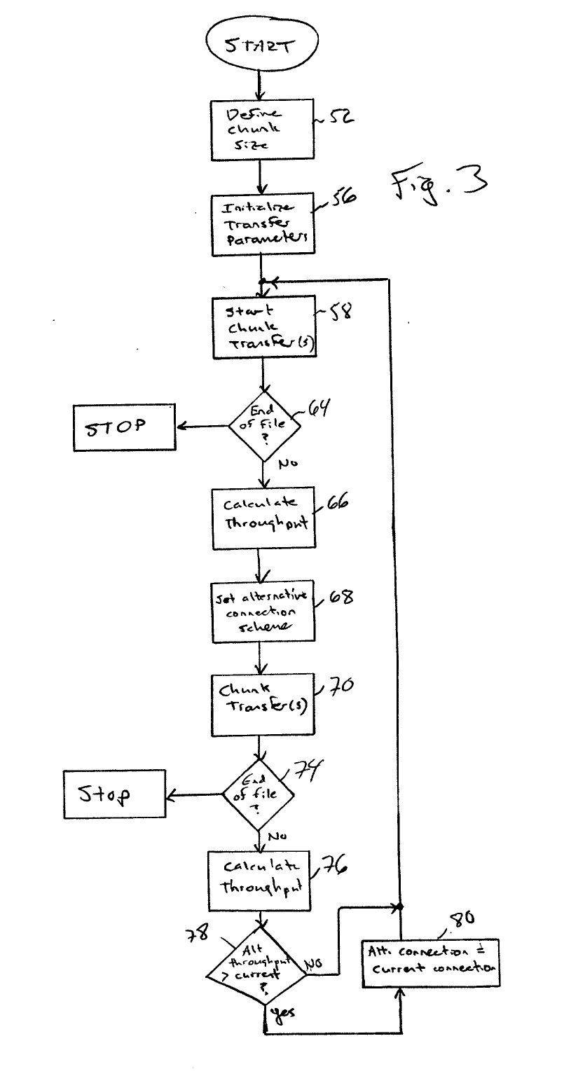

Referring to FIG. 3, at step 52 the chunk 54 size is determined according to the type of network connection the client computer 14 has. For example, a modem connection uses one chunk size, while a high speed local area network gateway uses another chunk size. At step 56, the file transfer parameters are set including setting the initial number of connections. The initial number of connections is the current connection scheme. At step 58, the file transfer commences. For the initial chunk transfers, an initial number of network connections is used. For the embodiment using two connections as the initial configuration, chunk 1 is received/sent over a first connection 60, while a second chunk is received/sent over a second connection 62. The send or receive operation is based on whether the client computer 14 is uploading or downloading the file 50.

Upon completion of the chunk transfers, the transfer status is tested at step 64 to determine if the end of the file has been reached. If it has, then the file transfer is complete. If it has not, then at step 66, the throughput for the chunk transfer is calculated. In one embodiment the throughput is calculated as the current time less the chunk transfer start time, divided by the number of connections. This is the throughput for transferring one chunk 54.

At step 68, an alternative connection scheme is set for the next chunks being transferred. In one embodiment the alternative scheme is one connections more than the current connection scheme. In other embodiments, the alternative connection scheme is one less than the current connection scheme. In still other embodiments, the increment of decrement in the number of connections is other than 1, (e.g., 2, 3). At step 70, the subsequent chunks then are sent/received using the alternative connections scheme. Referring to FIG. 4, an alternative connections scheme includes three connections 60, 62 and 72. In such case, the next chunks 54, (e.g., chunk 3, chunk 4 and chunk 5) are sent/received.

After these subsequent chunks are transferred, at step 74, the transfer status again is tested to determine whether the end of the file 50 has been reached. If not then the throughput using the alternative connection scheme is determined at step 76. The throughputs are compared at step 78. If the throughput using the alternative connection scheme is faster, then at step 80, the alternative connection scheme becomes the new current connection scheme. Otherwise, the current connections scheme remains unchanged.

The process steps 58-80 repeat for subsequent chunk transfers. In various iterations, however the alternative connection scheme tested varies according to prior results. For example, the alternative connection scheme varies between plus one and minus one connections under conditions where the current connection scheme is unchanged. In the preferred embodiment, the alternative connection scheme varies between, plus one, minus one and the same number of connections under conditions where the current connection scheme is unchanged. For the same number of connections alternative, at least one of the connections is substituted with another connection line. Further, the increment or decrement is a one connection increment/decrement in some embodiments and a larger increment/decrement in other embodiments.

In cases where the current connection scheme does change, the alternative connections scheme increments or decrements in the same direction for a preferred embodiment. The increment or decrement is a one connection increment/decrement in some embodiments and by a larger increment/decrement in other embodiments. In an alternative embodiment, the alternative connection schemes also include an alternative having the same number of connections with at least one connection being substituted by another connection line.

Accordingly, in some embodiments the alternative connection schemes do not just include schemes which vary the number of connections, but also the connections themselves. Where an alternative connection scheme in one embodiment includes the same number of connections, one or more of the current connections is substituted with another connection. Such substitution also is performed in some embodiments where the number of connections is changed. For example, when incrementing the number of connections, one or more of the current connections is substituted with a new connections, while also adding new connections for the incremental increase. Similarly, when decrementing the number of connections, in addition to removing the decremental number of connections, another connection also is substituted.

Pseudocode of a Specific Embodiment

Note in this pseudocode embodiment the initial connection scheme is for 3 connections.

The following pseudocode is subject to copyright protection. (C) Copyright 2001 Acceleration Software International Corporation

[image]

[image]

[image]

[image]

The above does assume that requests complete in roughly a first in first out order, but the adaptiveness allows out of sequence completions to be treated as noise, which automatically gets filtered out. As get( )'s complete out of sequence or there is artificially high, or low, results based on the timing, the Current_Connections gets changed, but what happens is that it will bounce around and possibly end up alternating between two values, or sometimes end up in a more complex pattern. Any single sample at the wrong value does not hurt performance significantly because it collapses into the 1 connection case to avoid deceleration. The sampling is happening without stopping the transfers.

Alternate embodiments can use different comparisons as triggers on changing Current_Connections. The following are alternate triggers for increasing and decreasing the number of connections:

Alternate increase triggers:

If (minus_one>=current && current>=plus_one

If (minus_one>=current && current>plus_one)

If (minus_one>current && current>=plus_one)

If (minus_one>current && current>plus_one)

If (minus_one>current && minus_one>plus_one)

If (minus_one>=current && minus_>=plus_one)

If (minus_one>=current && minus_one>plus_one)

If (minus_one>current && minus_one>=plus_one)

If (minus_one>plus_one && current>plus_one)

If (minus_one>=plus_one && current>=plus_one)

If (minus_one>=plus_one && current>plus_one)

If (minus_one>plus_one && current>=plus_one)

Alternate decrease triggers:

if (plus_one>current && current>minus_one)

if (plus_one>=current && current>=minus_one)

if (plus_one>=current && current>minus_one)

if (plus_one>current && current>=minus_one)

if (plus_one>current && plus_one>minus_one)

if (plus_one>=current && plus_one>=minus_one)

if (plus_one>=current && plus_one>minus_one)

if (plus_one>current && plus_one>=minus_one)

if (plus_one>minus_one && current>minus_one)

if (plus_one>=minus_one && current>=minus_one)

if (plus_one>=minus_one && current>minus_one)

if (plus_one>minus_one && current>=minus_one)

Meritorious and Advantageous Effects

According to one advantage of the invention, file transfer time is decreased by dynamically determining an optimum number of connections. Further, as the determined optimum number changes during a file transfer, the number of connections is changed correspondingly. A benefit of this is that a more reliable method of accelerating file transfers is achieved with the risk of actually decelerating the transfer process being reduced.

Although a preferred embodiment of the invention has been illustrated and described, various alternatives, modifications and equivalents may be used. Therefore, the foregoing description should not be taken as limiting the scope of the inventions which are defined by the appended claims.

What is claimed is:

1. A method for transferring a file between a file server and a client computer on a wide area network, comprising the steps of:
setting an initial number of network connections between the file server and client computer to perform a file transfer, the initial number being at least one connection;
commencing the file transfer using at least one connection between the file server and the client computer, said at least one connection corresponding to the initial number of connections;
during the file transfer, estimating file transfer throughput for each one a plurality of connections schemes;
when the step of estimating identifies a faster throughput as being achievable using an alternative connection scheme among the plurality of connection schemes, changing the at least one connection currently in use to said alternative connection scheme.

2. The method of claim 1, wherein the step of commencing comprises performing a chunk transfer, wherein a chunk is a portion of the file, and wherein the step of estimating estimates throughput for the chunk transfer.

3. The method of claim 2, wherein for a subsequent chunk of the file an alternative number of connections is used and wherein throughput is estimated for transfer of said subsequent chunk, the method further comprising the step of:
comparing the throughput estimated for the subsequent chunk to the throughput estimated for a prior chunk;
when the throughput estimated for the subsequent chunk exceeds the throughput estimated for the prior chunk, setting the current number of connections to that used for said subsequent chunk.

4. The method of claim 3, wherein said alternative number of connections exceeds the initial number of network connections.

5. The method of claim 3, wherein said alternative number of connections is less than the initial number of network connections.

6. The method of claim 3, wherein for a later chunk following said subsequent chunk, another alternative number of connections is used and wherein throughput is estimated for transfer of said later chunk, the method further comprising the step of:
comparing the throughput estimated for the later chunk to the throughput estimated for said subsequent chunk;
when the throughput estimated for the later chunk exceeds the throughput estimated for the subsequent chunk, setting the current number of connections to that used for said later chunk.

7. The method of claim 6, wherein said alternative number of connections exceeds the initial number of network connections.

8. The method of claim 6, wherein said alternative number of connections is less than the initial number of network connections.

9. The method of claim 1, wherein the plurality of connection schemes comprises the at least one connection currently in use.

10. The method of claim 1, wherein the plurality of connection schemes comprises a first alternative connection scheme comprising one connection more than the at least one connection currently in use.

11. The method of claim 1, wherein when the at least one connection currently in use is at least two connections, the plurality of connection schemes comprises a first alternative connection scheme having one connection less than the at least two connections.

12. The method of claim 1, wherein the plurality of connection schemes comprises a first alternative connection scheme which does not include at least one connection among the at least one connection currently in use.

13. The method of claim 1, wherein the file transfer is performed in chunks and comprises a plurality of chunk transfers, a chunk being a portion of the file, each one connection of the at least one connection performing a chunk transfer, and wherein the step of estimating occurs during the chunk transfer of said each one connection, said alternative connection scheme being used for a later chunk transfer among the plurality of chunk transfers.

14. The method of claim 1, wherein the file transfer is performed in chunks and comprises a plurality of chunk transfers, a chunk being a portion of the file, each one connection of the at least one connection performing a chunk transfer, and wherein the step of changing occurs after one of the plurality of chunk transfers, said alternative connection scheme being used for a later chunk transfer among the plurality of chunk transfers.
